(19) United States
(12) Patent Application Publication
(10) Pub. No.: US 2024/0132023 A1
(43) Pub. Date: Apr. 25, 2024

(54) Camera Field of View Cleaning System

(71) Applicants: Martin D. Herman, Chicago, IL (US); Jake Herman, Chicago, IL (US)

(72) Inventors: Martin D. Herman, Chicago, IL (US); Jake Herman, Chicago, IL (US)

(21) Appl. No.: 17/972,890

(22) Filed: Oct. 24, 2022

(51) Int. Cl. B60S 1/56; B08B 1/00; B08B 3/02

(52) U.S. Cl. CPC B60S 1/56; B08B 1/006; B08B 3/02

(57) ABSTRACT

A camera cleaning system for cleaning a field of view of a camera includes a cover having a three-dimensional surface positioned at least partially around a longitudinal axis and extending through an opening in a housing. The cover defines a chamber in which a camera may be mounted. The cover is configured to rotate around the longitudinal axis while a wiper positioned along the opening of the housing engages the three-dimensional surface of the cover, thereby cleaning a field of view of a camera when a camera is mounted therein.

### FIELD OF THE DISCLOSURE

This disclosure relates generally to a cleaning system for a field of view of a camera, and specifically to a camera cleaning system including a rotatable cylinder and wiper for continuous cleaning.

### BACKGROUND

Cameras are used to continuously assess potential threats and environmental conditions. For example, cameras are routinely mounted on buildings for security purposes. When a camera is mounted on a vehicle, the images collected by the camera may assist a driver or may allow the car to drive partially or fully autonomously. In order for the images collected by the camera to be useful, the camera must have a clean field of view. Unfortunately, cameras are rarely provided with any means by which to clean the field of view of the camera and the existing cleaning solutions are often inadequate to resolve camera blurriness.

### SUMMARY

According to a first aspect, a camera cleaning system for cleaning a field of view of a camera includes a cover, a base, a motor, and a wiper. The cover has a three-dimensional surface positioned at least partially around a longitudinal axis and defines a chamber. The base is positioned within the chamber along the longitudinal axis and includes a camera mount. The motor is operably coupled to the cover to rotate the cover around the longitudinal axis. A wiper is positioned to engage the three-dimensional surface of the cover.

In some arrangements, the cover may define an optical pathway from the chamber that is perpendicular to the longitudinal axis. The camera may be mounted on the camera mount of the base within the chamber, and a field of view of the camera may extend through the optical pathway. The field of view of the camera may have a radial distance relative to the longitudinal axis of at least π radians.

In further arrangements, the cover may be one of a cylinder and a half-sphere.

In still further arrangements, the cover, the base, and the motor are disposed in the housing, and the housing includes an opening through which the three-dimensional surface of the cover extends. The opening of the housing may include a first side and a second side. An optical pathway may extend through the opening of the housing between the first side and the second side. The wiper may be a first wiper positioned along the first side of the opening to engage the three-dimensional surface of the cover, and a second wiper may be positioned along the second side of the opening to engage the three-dimensional surface of the cover. The motor may be configured to rotate the cover in a first direction such that the first wiper engages the three-dimensional surface of the cover immediately before the three-dimensional surface rotates into the optical pathway, and the motor may further be configured to rotate the cover in a second direction such that the second wiper engages the three-dimensional surface of the cover immediately before the three-dimensional surface rotates into the optical pathway.

In some arrangements, the camera cleaning system may further include a fluid reservoir fluidly coupled to a spray outlet and a pump. The pump may be configured to pump fluid from the fluid reservoir through the spray outlet. The spray outlet may be positioned to direct fluid from the fluid reservoir toward the cover when the pump is pumping fluid.

In further arrangements, the wiper may be connected to an exterior of the housing to facilitate replacement.

In some arrangements, the cleaning system may further include a temperature control configured to at least one of adjust a temperature within the chamber of the cover, adjust a temperature of a housing in which the cover is disposed, and adjust a temperature of the three-dimensional surface of the cover.

In further arrangements, the base may comprise a plurality of camera mounts. The cover may define an optical pathway from the chamber. A plurality of cameras may be mounted on respective camera mounts of the plurality of camera mounts, and each camera may have a field of view through the optical pathway that differs at least in part from the field of view of at least one other of the plurality of cameras. The field of view of each camera may contribute to a collective field of view of the plurality of cameras, and the collective field of view may have a radial distance relative to the longitudinal axis of 2π radians.

According to a second aspect, a camera optimization system may include a cover, a base, and a motor. The cover has a three-dimensional surface positioned at least partially around a longitudinal axis and defines a chamber. The base is positioned within the chamber along the longitudinal axis and includes a camera mount. The motor is operably coupled to the cover to rotate the cover around the longitudinal axis. The three-dimensional surface of the cover has a plurality of areas, each of the areas having at least one visual effect that differs from a visual effect of another of the areas.

In some arrangements, the at least one visual effect may be at least one of a polarization, tinting, color, and refractive index. In some arrangements, the three-dimensional surface of the cover may include on or more visual marks for image analysis.

In yet additional arrangements, the chamber may be sealed to maintain a vacuum within the chamber.

According to a third aspect, a method of cleaning a field of view of a camera includes providing a cover having a three-dimensional surface positioned at least partially around a longitudinal axis and defining a chamber. The method further includes mounting a camera within the chamber along the longitudinal axis and directing a field of view of the camera through an optical pathway perpendicular to the longitudinal axis. The method further includes rotating the cover around the longitudinal axis and wiping the cover with a wiper.

In some forms, the method may further include rotating the camera at variable speeds to facilitate cleaning debris.

In other forms, the method may further include providing at least one visual mark on the three-dimensional surface of the cover, capturing a plurality of images using the camera, and analyzing the captured images to determine a speed difference between the camera and an external object captured in the plurality of images based on a rotation rate of the three-dimensional surface and a distance that the at least one visual mark has moved relative to the external object.

In still additional forms, the method may include detecting an obstruction in the field of view of the camera and rotating the cover in response to detecting the obstruction.

### BRIEF DESCRIPTION OF THE DRAWINGS

FIG. 1 is a perspective view of a camera cleaning system having a cover that is a cylinder and a fluid delivery system.

FIG. 2 is an exploded view of the camera cleaning system of FIG. 1.

FIG. 3 is a perspective view of a camera cleaning system having a cover that is a half-sphere and a temperature control.

FIG. 4 is an exploded view of the camera cleaning system of FIG. 3.

FIG. 5 is a perspective view of a camera cleaning system having a plurality of camera mounts and cameras.

FIG. 6 is a perspective view of a cover for a camera cleaning system having a plurality of areas with different visual effects.

FIG. 7 is a perspective view of a cover for a camera cleaning system having visual marks for image analysis.

FIG. 8 illustrates schematically a method of cleaning a field of view of a camera using a camera cleaning system.

### DETAILED DESCRIPTION

Generally, a camera cleaning system for cleaning a field of view of a camera is disclosed. The camera cleaning system includes a cover with a three-dimensional surface that rotates around a longitudinal axis within a housing and is cleaned by at least one stationary wiper secured to the housing. The cover defines a chamber into which one or more cameras are placed. Because the wiper is stationary, the wiper never obstructs the view through the cover and therefore never introduces an artifact into the images collected by the camera. The three-dimensional surface will typically be convex (e.g., the cover may be a cylinder or half-sphere), and debris consequently has a tendency to wash away from the cover as it rotates due to the tangential force generated by the rotation. The chamber may be sealed to prevent the accumulation of humidity within the cover and to allow the camera to be submerged. The chamber may contain a vacuum, which prevents pressure differentials between the chamber and the external environment from damaging the cover. The camera system can be a camera optimization system with different areas of the cover having different visual effects, which are implemented by rotating the cover. For example, the thickness of the cover may vary so that the refractive index changes depending on the area of the cover through which the camera's field of view is extending.

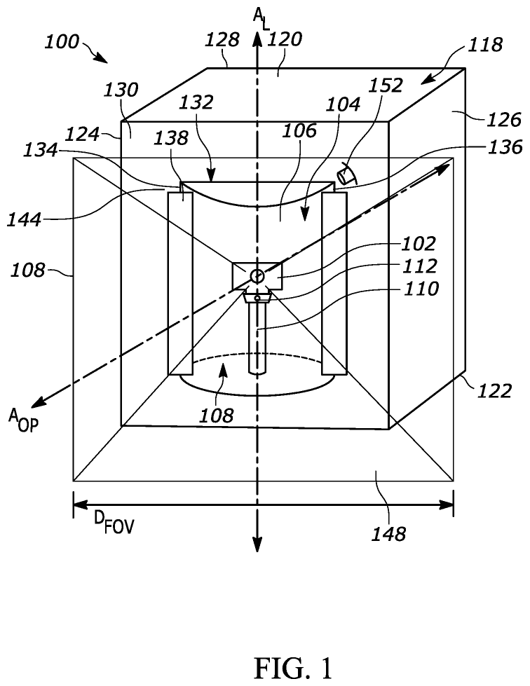

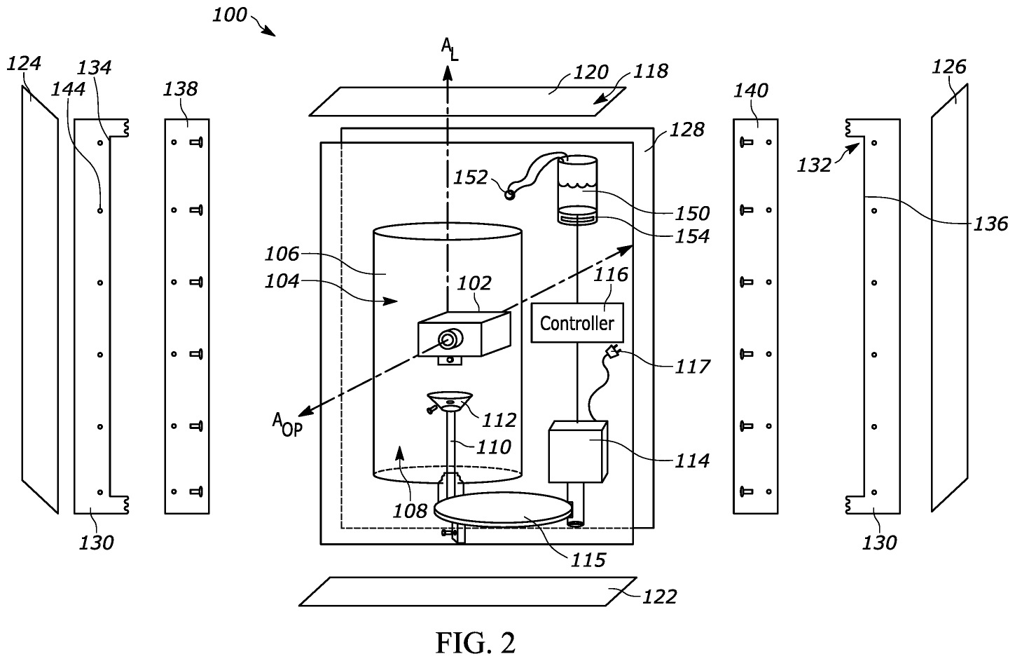

FIGS. 1 and 2 illustrate a camera cleaning system 100 for cleaning a field of view (FOV) of a camera 102. The system 100 includes a cover 104 that has a three-dimensional surface 106. The three-dimensional surface 106 is positioned at least partially around a longitudinal axis A_{L} and defines a chamber 108. As discussed above, the chamber 108 may be sealed to maintain a vacuum within the chamber 108. Alternately, the chamber 108 may be vented to allow adjustments to an atmosphere within the chamber 108.

The three-dimensional surface 106 will typically form, in part or in full, a shape that has continuous rotational symmetry around the longitudinal axis A_{L}, such as a cylinder, sphere, or cone. In FIGS. 1 and 2, the three-dimensional surface 106 forms a cylinder. However, in some systems, the three-dimensional surface 106 may form, in part or in full, a shape having discrete rotational symmetry around the longitudinal axis A_{L}, such as a prism or a pyramid. The cover 104 comprises a light-transmissive material that allows the camera 102 to capture images through the cover 104. For example, the cover 104 may be transparent or translucent. The cover 104 may, for example, comprise glass or acrylic. The cover 104 may be treated to maintain the transmissibility of light by, for example, an anti-fog solution.

A base 110 is positioned within the chamber 108 along the longitudinal axis A_{L}. The base 110 includes a camera mount 112 on which the camera 102 is positioned. For example, the camera 102 may be connected to the camera mount 112 by a screw, by adhesive, or by another typical fastener. In the arrangement shown in FIG. 1, the camera 102 is positioned on the longitudinal axis A_{L} by the camera mount 112. However, in other arrangements, the camera 102 may be offset from the longitudinal axis A_{L} when mounted on the base 110.

As shown in FIG. 2, a motor 114 is operably coupled to the cover 104 to rotate the cover 104 around the longitudinal axis A_{L}. The motor 114 may be coupled to the cover 104 by, for example, one or more gears 115. The motor 114 can be controlled in a variety of ways to facilitate use of the system 100 by a controller 116, which includes a processor. For example, the motor 114 can be controlled to create a variable speed of rotation to assist with cleaning away debris. The motor 114 may be controlled to be activated by conditions determined from images taken by the camera 102 and received by the controller 116. For example, if images taken by the camera 102 indicate the presence of water or debris on the cover 104, the controller 116 may instruct the motor 114 to rotate the cover 104. The controller 116 may instruct the motor 114 to stop rotating the cover 104 after the cover 104 has rotated a certain distance or when images taken by the camera 102 no longer indicate the presence of water or debris. The controller 116 may communicate wirelessly with the camera 102 and/or the motor 114 or may have a wired connection with the camera 102 and/or the motor 114. A power source 117 may be provided to power the motor 114. The power source 117 may be a connection to an external power source or may be batteries provided as part of the system 100.

As shown in FIGS. 1 and 2, the cover 104, the base 110, and the motor 114 are disposed within a housing 118. The controller 116 may be positioned within the housing 118 or may be outside the housing 118. The housing 118 shown in FIGS. 1 and 2 includes a top 120, a bottom 122, a first lateral side 124, a second lateral side 126, a back 128, and a front 130. Other housing shapes and configurations are possible. The housing 118 includes an opening 132 through which the three-dimensional surface 106 of the cover 104 extends. The opening 132 in FIGS. 1 and 2 has a first opening side 134 and a second opening side 136.

As shown in FIGS. 1 and 2, a first wiper 138 is positioned along the first opening side 134 and a second wiper 140 is positioned along the second opening side 136 to engage the three-dimensional surface 106 of the cover 104. The first wiper 138 and the second wiper 140 are connected to an exterior 144 of the housing 118 to facilitate easy replacement when necessary. For example, the first wiper 138 and the second wiper 140 may have apertures 146 to accommodate screws for fastening.

The cover 104 and the opening 132 define an optical pathway A_{OP} that is perpendicular to the longitudinal axis A_{L}. Although illustrated as an axis, the optical pathway A_{OP} has a height and width at least sufficient to allow the camera 102 to capture images via the optical pathway A_{OP}. As best shown in FIG. 1, when the camera 102 is mounted on the camera mount 112, a field of view (FOV) 148 extends through the optical pathway A_{OP}. In FIG. 1, the FOV 148 has a radial distance D_{FOV} relative to the longitudinal axis A_{L} of approximately π radians. In other arrangements, the radial distance D_{FOV} may be greater or less than π radians.

The motor 114 is configured to rotate the cover 104 in a first direction such that the first wiper 138 engages the three-dimensional surface 106 of the cover 104 immediately before the three-dimensional surface 104 rotates into the optical pathway A_{OP}, and the motor 114 is further configured to rotate the cover 114 in a second direction such that the second wiper 140 engages the three-dimensional surface 106 of the cover 104 immediately before the three-dimensional surface 106 rotates into the optical pathway A_{OP}. That is, prior to rotating into the optical pathway A_{OP}, the last contact that the portion of the three-dimensional surface 106 now positioned in the optical pathway A_{OP} had was with either the first wiper 138 or the second wiper 140, depending on the direction that the three-dimensional surface 106 is rotated.

The system 100 of FIGS. 1 and 2 further includes a fluid reservoir 150 fluidly coupled to a spray outlet 152 and a pump 154. The pump 154 is configured to pump fluid from the fluid reservoir 150 through the spray outlet 152. The spray outlet 152 is positioned to direct fluid from the fluid reservoir 150 toward the cover 104 when the pump 154 is pumping fluid. As shown in FIGS. 1 and 2, the spray outlet 152 is provided in the front 130 of the housing 118 near the opening 132. The pump 154 may be connected to the power source 117 and the controller 116. Alternately, a separate power source and/or controller may be connected to the pump 154. The controller 116 may be used to determine when the pump 154 is activated. For example, the pump 154 may be activated whenever the cover 104 is rotating.

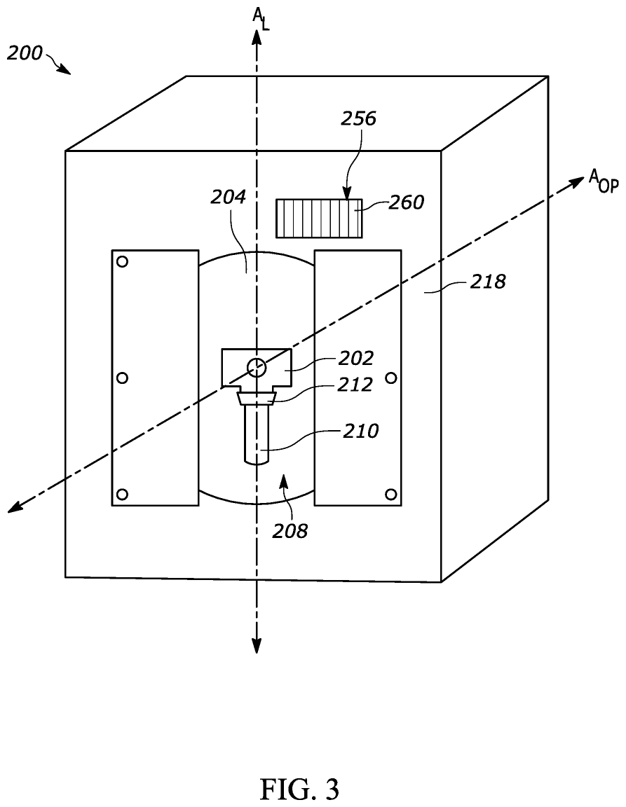

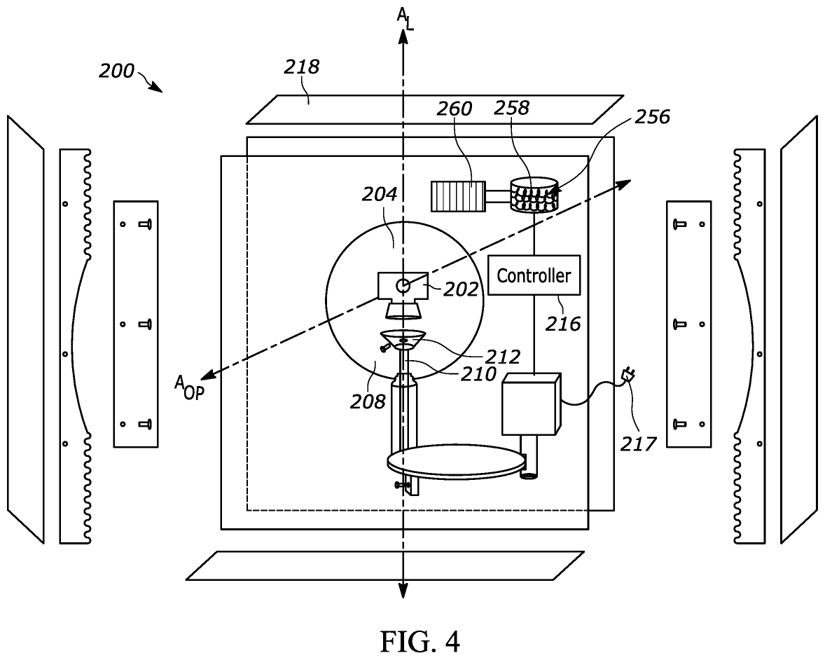

Turning to FIGS. 3 and 4, a system 200 is illustrated that may include similar features to the system 100 and/or may be an expansion of the system 100, and thereby elements illustrated in FIGS. 3 and 4 are designated by similar reference numbers indicated on the arrangements illustrated in FIGS. 1 and 2, increased by 100. Accordingly, these features will not be described in substantial detail. Further, it is appreciated that any combination or sub-combination of features described in regard to the system 200 may be incorporated into the system 100, and vice-versa.

The system 200 includes a cover 204 having a three-dimensional surface 206 that is a half-sphere. The three-dimensional surface 206 is configured to rotate around the longitudinal axis A_{L}. However, the three-dimensional surface 106 in FIGS. 1 and 2 can rotate 360 degrees around the longitudinal axis A_{L} and may rotate continuously in a single direction. In contrast, the half-sphere can rotate only partially around the longitudinal axis A_{L} in a first direction and must then reverse to rotate that opposite direction in order to ensure that the three-dimensional surface remains within the optical pathway A_{OP}. The half-sphere provides easier access to the chamber 208 to, for example, place the camera 202 on the base 210 via the camera mount 212. A three-dimensional surface 206 that fully forms a geometric shape (e.g., a cylinder or full sphere) may be preferable when a chamber, such as chamber 108, is to contain a vacuum. A partial geometric shape (e.g., a half sphere) may be preferable when the chamber, such as chamber 208, is to contain an adjustable atmosphere.

To that end, the system 200 includes a temperature control 256. The temperature control 156 may be a heater or a cooling device 258 and may further include a fan or vent system 260 to distribute the heated or cooled air as shown in FIG. 4. The temperature control 256 may be connected to the controller 216 and power source 217 as the motor 214 or may have a separate controller and power source. The vent system 260 shown in FIGS. 3 and 4 directs the heated or cooled air onto the three-dimensional surface 206 outside the housing 218 to adjust the temperature of the three-dimensional surface 206. In other arrangements, the vent system 160 may direct the heated or cooled air to the chamber 208 to adjust the temperature within the chamber 208 or may distribute the heated or cooled air throughout the housing 218 generally to adjust the temperature of the system 200 as a whole.

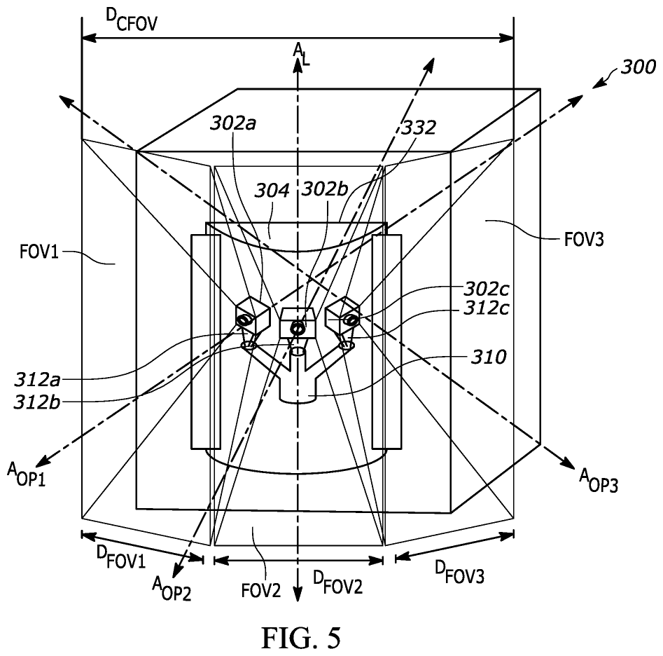

Turning to FIG. 5, a system 300 is illustrated that may include similar features to the systems 100 and 200 and/or may be an expansion of the systems 100 and 200, and thereby elements illustrated in FIG. 5 are designated by similar reference numbers indicated on the arrangements illustrated in FIGS. 1 1-4, increased by a multiple of 100. Accordingly, these features will not be described in substantial detail. Further, it is appreciated that any combination or sub-combination of features described in regard to the system 300 may be incorporated into the system 100 or the system 200, and vice-versa.

The system 300 includes a base 310 that has three camera mounts 312a, 312b, and 312c on which a respective camera 302a, 302b, and 302c is mounted. In other arrangements, the system 300 may include only two camera mounts 312 and two cameras 302 or may include more than three camera mounts 312 and more than three cameras 302. The cover 304 and the opening 332 define a collective optical pathway through which a first optical pathway A_{OP1} associated with the first camera 302a, a second optical pathway A_{OP2} associated with the second camera 302b, and a third optical pathway A_{OP3} associated with the third camera 302c extend. The first camera 302a has a first field of view FOV1 through the collective optical pathway along the first optical pathway A_{OP1}. The second camera 302b has a second field of view FOV2 through the collective optical pathway along the second optical pathway A_{OP2}. The third camera 302c has a third field of view FOV3 through the collective optical pathway along the third optical pathway A_{OP3}.

As shown in FIG. 5, each of the fields of view FOV1, FOV2, and FOV3 differ at least in part from one another. For example, each of the fields of view FOV1, FOV2, and FOV3 are angled differently such that FOV1 and FOV3 allow image capture peripheral to the image capture accomplished within FOV2. Each of the fields of view FOV1, FOV2, and FOV3 may have different heights and widths. One or more of the cameras 312a, 312b, or 312c may be able to capture color images via a respective field of view FOV1, FOV2, or FOV3, and/or one or more of the cameras 312a, 312b, or 312c may capture only black and white images via a respective field of view FOV1, FOV2, or FOV3.

Each field of view FOV1, FOV2, and FOV3 has a respective radial distance D_{FOV1}, D_{FOV2}, and D_{FOV3}. When combined, the fields of view FOV1, FOV2, and FOV3 form a collective field of view having a collective radial distance D_{CFOV} relative to the longitudinal axis A_{L}. The fields of view FOV1, FOV2, and FOV3 may overlap such that the collective radial distance D_{CFOV} is less than the sum of D_{FOV1}, D_{FOV2}, and D_{FOV3}. In FIG. 5, the collective radial distance D_{CFOV} is approximately 1T radians (180 degrees). In some arrangements, the collective radial distance D_{CFOV} may be greater than or equal to π radians. As an example, in some arrangements, the housing 318 may be configured such that a plurality of cameras 302 are oriented to have a full surround view of the environment such that the collective radial distance D_{CFOV} is 2π radians (360 degrees).

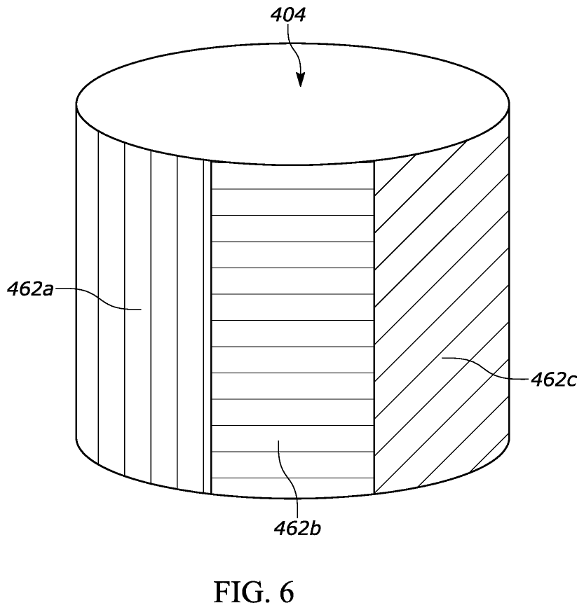

Turning to FIG. 6, a cover 404 is illustrated that may include similar features to the covers 104, 204, and 304 and/or may be an expansion of the covers 104, 204, and 304, and thereby elements illustrated in FIG. 6 are designated by similar reference numbers indicated on the arrangements illustrated in FIGS. 1-5, increased by a multiple of 100. Accordingly, these features will not be described in substantial detail. Further, it is appreciated that any combination or sub-combination of features described in regard to the cover 404 may be incorporated into the covers 104, 204, and 304, and vice versa.

In FIG. 6, the cover 404 has a three-dimensional surface 406 that has a plurality of areas 462a, 462b, and 462c. Each of the areas 462a, 462b, and 462c have at least one visual effect that differs from a visual effect from another of the areas 4621, 462b, and 462c. The at least one visual effect may be at least one of a polarization, tinting, color, and refractive index. For example, area 462a may have a lighter tint than area 462b, which may have a lighter tin that area 462c. The cover 404 may be rotated depending on lighting conditions so that an optical path A_{OP} extends through whichever of the areas 462a, 462b, and 462c will the best image collection by a camera (such as camera 102). Similarly, by changing a shape or thickness of each area 462a, 462b, and 462c, the areas 462a, 462b, and 462c may have different refractive indexes and the cover 404 may be rotated to use the refractive index that allows for the best focusing under particular conditions. The cover 404 may be used as part of a camera optimization system to increase the efficacy of the camera (such as camera 102) with or without the cleaning features discussed above (e.g., the wipers 138 and 140).

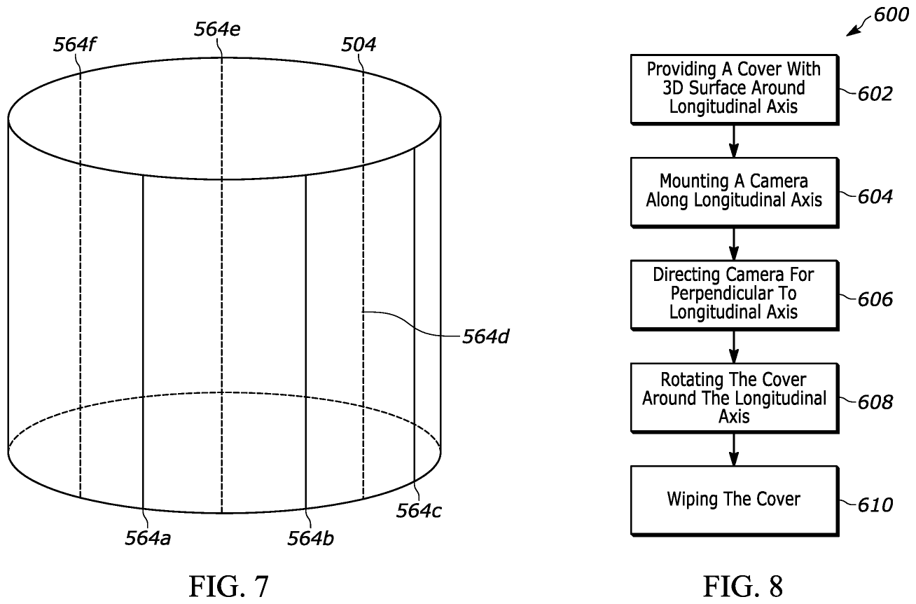

Turning to FIG. 7, a cover 504 is illustrated that may include similar features to the covers 104, 204, 304, and 404 and/or may be an expansion of the covers 104, 204, 304, and 404 and thereby elements illustrated in FIG. 7 are designated by similar reference numbers indicated on the arrangements illustrated in FIGS. 1-5, increased by a multiple of 100. Accordingly, these features will not be described in substantial detail. Further, it is appreciated that any combination or sub-combination of features described in regard to the cover 504 may be incorporated into the covers 104, 204, 304, and 404, and vice versa.

In FIG. 7, the cover 504 has a plurality of visual marks 564 (564a, 564b, 564c, 564d, 564e, and 564f) on the three-dimensional surface 506. The visual marks 564 are used for image analysis. In particular, the visual marks 564 function to assist with the instantaneous measurement of speed of movement based on a calculation of distance change relative to rotation rate. In particular, the visual marks 564 allow the capturing a plurality of images using a camera (such as camera 102) and analyzing the captured images to determine a speed difference between the camera and an external object captured in the plurality of images based on a rotation rate of the three-dimensional surface 506 and a distance that the at least one visual mark has moved relative to the external object.

FIG. 8 illustrates schematically a method 600 of cleaning a field of view (FOV) of a camera. At box 602, the method 600 includes providing a cover having a three-dimensional surface positioned at least partially around a longitudinal axis and defining a chamber, the cover disposed within a housing having an opening through which the three-dimensional surface of the cover extends. At box 604, the method 600 includes mounting a camera within the chamber along the longitudinal axis. At box 606, the method 600 includes directing a field of view of the camera through an optical pathway perpendicular to the longitudinal axis. At box 608, the method 600 includes rotating the cover around the longitudinal axis. At box 610, the method 600 includes wiping the cover with a wiper positioned along the opening of the housing.

Optionally, the method 600 may further include rotating the camera at variable speeds to facilitate cleaning debris. The method 600 may optionally include providing at least one visual mark on the three-dimensional surface of the cover, capturing a plurality of images using the camera, and analyzing the captured images to determine a speed difference between the camera and an external object captured in the plurality of images based on a rotation rate of the three-dimensional camera and a distance that the at least one visual mark has moved relative to the external object. The method 600 may optionally further include detecting an obstruction in the field of view of the camera and rotating the cover in response to detecting the obstruction.

1. A camera cleaning system for cleaning a field of view of a camera, the system comprising:
a cover having a three-dimensional surface positioned at least partially around a longitudinal axis and defining a chamber;
a base positioned within the chamber along the longitudinal axis, the base including a camera mount;
a motor operably coupled to the cover to rotate the cover around the longitudinal axis; and
a wiper positioned to engage the three-dimensional surface of the cover.

2. The camera cleaning system of claim 1, the cover defining an optical pathway from the chamber that is perpendicular to the longitudinal axis.

3. The camera cleaning system of claim 2, the camera mounted on the camera mount of the base within the chamber, a field of view of the camera extending through the optical pathway.

4. The camera cleaning system of claim 3, the field of view of the camera having a radial distance relative to the longitudinal axis of at least 1T radians.

5. The camera cleaning system of claim 1, the cover being one of a cylinder and a half-sphere.

6. The camera cleaning system of claim 1 further comprising
a housing in which the cover, the base, and the motor are disposed, the housing including an opening through which the three-dimensional surface of the cover extends,
the opening of the housing including a first side and a second side, an optical pathway extending through the opening of the housing between the first side and the second side,
the wiper being a first wiper positioned along the first side of the opening to engage the three-dimensional surface of the cover, and a second wiper positioned along the second side of the opening to engage the three-dimensional surface of the cover, and
the motor configured to rotate the cover in a first direction such that the first wiper engages the three-dimensional surface of the cover immediately before the three-dimensional surface rotates into the optical pathway, and the motor further configured to rotate the cover in a second direction such that the second wiper engages the three-dimensional surface of the cover immediately before the three-dimensional surface rotates into the optical pathway.

7. The camera cleaning system of claim 1 further comprising a fluid reservoir fluidly coupled to a spray outlet and a pump, the pump configured to pump fluid from the fluid reservoir through the spray outlet, the spray outlet positioned to direct fluid from the fluid reservoir toward the cover when the pump is pumping fluid.

8. The camera cleaning system of claim 1, the wiper connected to an exterior of the housing to facilitate replacement.

9. The camera cleaning system of claim 1 further comprising a temperature control configured to at least one of adjust a temperature within the chamber of the cover, adjust a temperature of a housing in which the cover is disposed, and adjust a temperature of the three-dimensional surface of the cover.

10. The camera cleaning system of claim 1, the base comprising a plurality of camera mounts.

11. The camera cleaning system of claim 10, the cover defining an optical pathway from the chamber, a plurality of cameras mounted on respective camera mounts of the plurality of camera mounts, each camera having a field of view through the optical pathway that differs at least in part from the field of view of at least one other of the plurality of cameras.

12. The camera cleaning system of claim 11, the field of view of each camera contributing to a collective field of view of the plurality of cameras, the collective field of view having a radial distance relative to the longitudinal axis of 2π radians.

13. A camera optimization system comprising:
a cover having a three-dimensional surface positioned at least partially around a longitudinal axis and defining a chamber;
a base positioned within the chamber along the longitudinal axis, the base including a camera mount; and
a motor operably coupled to the cover to rotate the cover around the longitudinal axis;
the three-dimensional surface of the cover having a plurality of areas, each of the areas having at least one visual effect that differs from a visual effect of another of the areas.

14. The camera optimization system of claim 13, the at least one visual effect being at least one of a polarization, tinting, color, and refractive index.

15. The camera optimization system of claim 13, the three-dimensional surface of the cover comprising one or more visual marks for image analysis.

16. The camera optimization system of claim 13, wherein the chamber is sealed to maintain a vacuum within the chamber.

17. A method of using the camera cleaning system of claim 1, the method comprising:
providing the cover having the three-dimensional surface positioned at least partially around the longitudinal axis and defining the chamber;
mounting the camera within the chamber along the longitudinal axis;
directing the field of view of the camera through an optical pathway perpendicular to the longitudinal axis;
rotating the cover around the longitudinal axis; and
wiping the cover with a wiper.

18. The method of claim 17, further comprising rotating the camera at variable speeds to facilitate cleaning debris.

19. The method of claim 17, further comprising providing at least one visual mark on the three-dimensional surface of the cover, capturing a plurality of images using the camera, and analyzing the captured images to determine a speed difference between the camera and an external object captured in the plurality of images based on a rotation rate of the three-dimensional camera and a distance that the at least one visual mark has moved relative to the external object.

20. The method of claim 17, further comprising detecting an obstruction in the field of view of the camera and rotating the cover in response to detecting the obstruction.
